(19) United States
(12) Patent Application Publication
(10) Pub. No.: US 2025/0022648 A1
(43) Pub. Date: Jan. 16, 2025

(54) MULTILAYER INDUCTOR, MULTILAYER INDUCTOR ARRAY, AND METHOD OF MANUFACTURING MULTILAYER INDUCTOR

(71) Applicant: Murata Manufacturing Co., Ltd., Kyoto-fu (JP)

(72) Inventors: Kozo SATO, Nagaokakyo-shi (JP); Ryota WATANABE, Nagaokakyo-shi (JP)

(73) Assignee: Murata Manufacturing Co., Ltd., Kyoto-fu (JP)

(21) Appl. No.: 18/771,316

(22) Filed: Jul. 12, 2024

(30) Foreign Application Priority Data
Jul. 14, 2023 (JP) 2023-116137

(51) Int. Cl. H01F 27/28; H01F 27/255; H01F 27/29; H01F 27/32

(52) U.S. Cl. CPC H01F 27/2804; H01F 27/255; H01F 27/29; H01F 27/323; H01F 2027/2809

(57) ABSTRACT

A multilayer inductor includes an element body that constitutes a magnetic body by stacking magnetic layers containing iron powder and that has a coil obtained by winding a coil conductor inside the magnetic body, and an outer electrode that is electrically connected to the coil conductor. A resin is provided in voids inside the magnetic body, and the resin is provided in at least a part of pores in the coil conductor at least in a vicinity of a magnetic layer.

### CROSS-REFERENCE TO RELATED APPLICATION

This application claims benefit of priority to Japanese Patent Application No. 2023-116137, filed Jul. 14, 2023, the entire content of which is incorporated herein by reference.

### BACKGROUND

### Technical Field

The present disclosure relates to a multilayer inductor, a multilayer inductor array, and a method of manufacturing the multilayer inductor.

### Background Art

In recent years, DC-DC converters in voltage conversion circuits have become higher-current and higher-efficiency due to increased functionality of devices, and the rated current of power inductors used in these devices has also increased.

Japanese Unexamined Patent Application Publication No. 2007-27354, which describes an example of the above-described inductors, discloses a multilayer electronic component obtained by stacking metallic magnetic layers mainly composed of metallic magnetic particles and conductor patterns to form a coil in a multilayer body, and a method of manufacturing the multilayer electronic component.

### SUMMARY

In the multilayer electronic component, the metallic magnetic layers mainly composed of metallic magnetic particles have voids generated between the particles. The presence of the voids in the metallic magnetic layers causes decreasing in strength of the multilayer body (element body).

Accordingly, the present disclosure provides a multilayer inductor and a multilayer inductor array with improved element body strength, and a method of manufacturing the multilayer inductor.

A multilayer inductor of the present disclosure includes an element body that constitutes a magnetic body by stacking magnetic layers containing iron powder and that has a coil obtained by winding a coil conductor inside the magnetic body; and an outer electrode that is electrically connected to the coil conductor. Also, a resin is provided in voids inside the magnetic body, and pores exist in the coil conductor at least in a vicinity of a magnetic layer, and the resin is provided in at least a part of the pores.

A multilayer inductor array of the present disclosure includes an element body that constitutes a magnetic body by stacking magnetic layers containing iron powder and that has a coil obtained by winding a coil conductor inside the magnetic body; and an outer electrode that is electrically connected to the coil conductor. The coil includes two or more coils arranged to overlap each other in plan view from the stacking direction and arranged side by side in a direction intersecting the stacking direction to form a coil array. A resin is provided in voids inside the magnetic body, and the resin is provided in at least a part of pores in the coil conductor at least in a vicinity of a magnetic layer.

A method of manufacturing a multilayer inductor of the present disclosure includes an element body preparation step of preparing an element body that constitutes a magnetic body by stacking magnetic layers containing iron powder and that has a coil obtained by winding a coil conductor inside the magnetic body; a resin impregnation step of impregnating a resin into voids inside the magnetic body and into at least a part of pores in the coil conductor at least in a vicinity of a magnetic layer; and an outer electrode formation step of forming an outer electrode electrically connected to the coil conductor.

According to the present disclosure, it is possible to provide a multilayer inductor and a multilayer inductor array with improved element body strength, and a method of manufacturing the multilayer inductor. Specifically, in the element body of the multilayer inductor, since the resin is provided in the voids inside the magnetic body and in at least a part of the pores in the coil conductor at least in the vicinity of the magnetic layer, the voids and the pores can be reduced, and thereby element body strength can be increased.

### BRIEF DESCRIPTION OF THE DRAWINGS

FIG. 1 is a perspective view schematically showing an example of a multilayer inductor according to a first embodiment;

FIG. 2 is an exploded perspective view showing the internal structure of the multilayer inductor according to the first embodiment;

FIG. 3 is a sectional view of the multilayer inductor according to the first embodiment;

FIG. 4A is a partially enlarged sectional view of a Z1 portion of FIG. 3;

FIG. 4B is a partially enlarged sectional view of a Z2 portion of FIG. 3;

FIG. 5 is a sectional SEM photograph of the multilayer inductor according to the first embodiment;

FIG. 6 is an elemental analysis photograph explaining the result of an elemental analysis performed based on FIG. 5;

FIG. 7 is a sectional SEM photograph taken at a position different from FIG. 5;

FIG. 8 is a sectional view of a multilayer inductor according to a variation of the first embodiment;

FIG. 9 is a perspective view schematically showing an example of a multilayer inductor according to a second embodiment;

FIG. 10 is a perspective view schematically showing an example of a multilayer inductor array of the present disclosure; and

FIG. 11 is a flow chart showing a method of manufacturing the multilayer inductor of the present disclosure.

### DETAILED DESCRIPTION

A multilayer inductor of the present disclosure is described below. Note that the present disclosure is not limited to the following configurations and may be modified as appropriate to the extent not departing from the spirit of the present disclosure. Also, combinations of the individual preferred configurations described below are in the present disclosure.

The multilayer inductor of the present disclosure is used, for example, in a DC-DC converter. The multilayer inductor of the present disclosure can also be used in applications other than the DC-DC converter.

In the present specification, terms indicating relationships between elements (for example, “parallel to”, “orthogonal to”, and the like) and terms indicating the shape of an element not only literally mean the exact aspect, but also mean a substantially equivalent range, for example, with a difference of a few percent. Note that, in the present specification, the direction in which magnetic layers and a coil conductor constituting the element body are stacked is referred to as a “stacking direction”.

The drawings referred to below are schematic drawings, and their dimensions, scale of aspect ratio, and the like may differ from the actual product.

### Multilayer Inductor According to First Embodiment

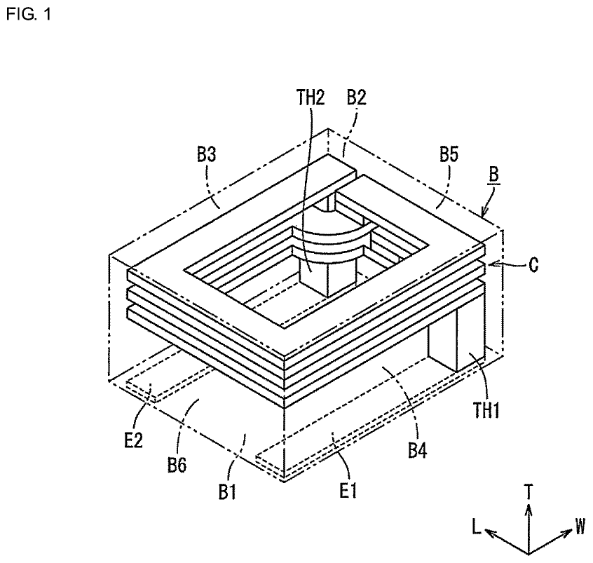

First, a multilayer inductor of a first embodiment according to the present disclosure is described with reference to FIGS. 1 to 8. The shape and arrangement of the multilayer inductor and each component thereof are not limited to the example shown in the drawings.

A multilayer inductor 1 shown in FIG. 1 includes an element body B and outer electrodes E, in which the element body B constitutes a magnetic body by stacking magnetic layers containing iron powder and has a coil C obtained by winding a coil conductor inside the magnetic body, and in which the outer electrodes E are electrically connected to the coil conductor. Each component is described in detail below.

### Element Body

The element body B has, for example, a rectangular parallelopiped shape or a substantially rectangular parallelopiped shape with six faces. The element body B may have rounded corner portions and ridge portions. The corner portion is where three surfaces of the element body B intersect, and the ridge portion is where two surfaces of the element body B intersect.

In FIG. 1, the length direction, the width direction, and the height direction in the multilayer inductor 1 and the element body B are indicated as an L direction, a W direction, and a T direction, respectively. The length direction L, the width direction W, and the height direction T are orthogonal to each other. The mounting surface of the multilayer inductor 1 is, for example, a plane (LW plane) parallel to the length direction L and the width direction W.

The element body B shown in FIG. 1 has a first main surface B1 and a second main surface B2 facing each other in the height direction T, a first end surface B3 and a second end surface B4 orthogonal to the height direction T and facing each other in the length direction L, and a first side surface B5 and a second side surface B6 facing each other in the width direction W orthogonal to the length direction L and the height direction T. In the example shown in FIG. 1, the first main surface B1 of the element body B corresponds to the mounting surface (the bottom surface) of the element body B. Note that the second main surface B2 may be the mounting surface of the element body B.

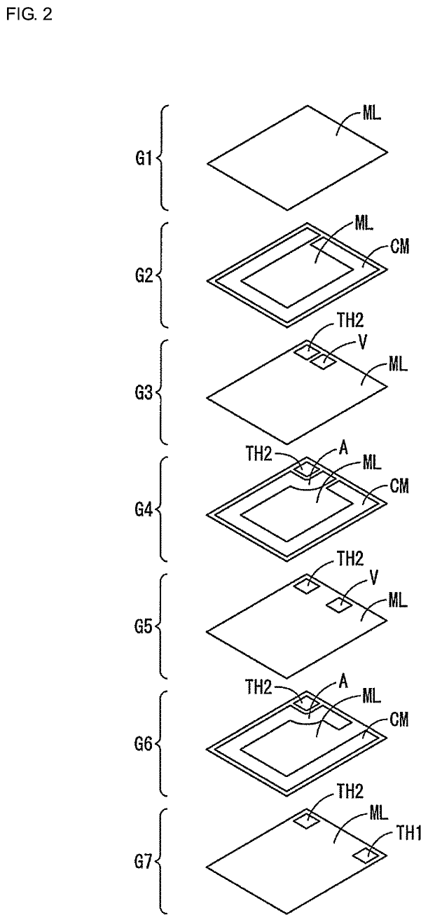

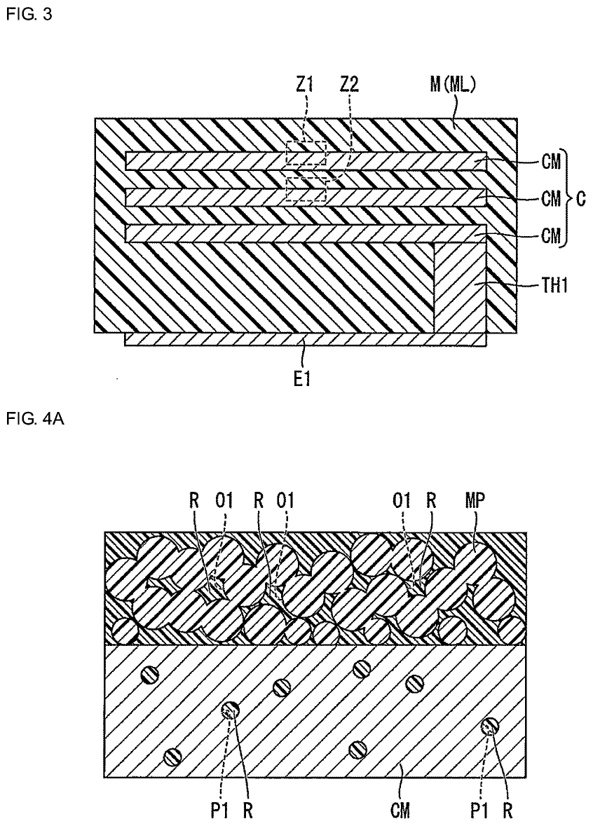

The element body B includes a magnetic body M obtained by stacking magnetic layers ML and a coil C obtained by winding a coil conductor CM (see FIGS. 2 and 3). Specifically, the element body B may include a plurality of magnetic layers ML and coil conductors CM in the stacking direction (for example, the height direction T). In the present embodiment, as shown in FIG. 2, the element body B is configured by stacking multilayer groups G1 to G7 that each include at least a magnetic layer ML and a coil conductor CM (or only the magnetic layer ML). The boundary of each layer of the multilayer structure that the element body B has may disappear. Each multilayer group may be formed by stacking a plurality of layers of the same pattern.

The multilayer group G1 has a magnetic layer ML and constitutes the second main surface B2 of the element body B.

The multilayer group G2 includes a magnetic layer ML and a coil conductor CM. The coil conductor CM of the multilayer group G2 constitutes one winding of the coil C. More specifically, the coil conductor CM is arranged substantially along the outer edge of the magnetic layer ML.

The multilayer group G3 includes a magnetic layer ML, a second through- conductor TH2 that electrically connects the coil conductor CM of the multilayer group G2 and a second outer electrode E2, and a via conductor V that connects adjacent coil conductors CM in the stacking direction. The second through-conductor TH2 is arranged in a corner portion of the magnetic layer ML. The via conductor V is arranged adjacent to the second through-conductor TH2.

The multilayer group G4 includes a magnetic layer ML, a second through-conductor TH2 that electrically connects the second through-conductor TH2 of the multilayer group G3 and the second outer electrode E2, and a coil conductor CM. The coil conductor CM of the multilayer group G4 constitutes one winding of the coil C. More specifically, the coil conductor CM is arranged along the outer edge of the magnetic layer ML while avoiding the second through-conductor TH2 with an avoidance portion A, and the end portions of the coil conductor CM are separated from each other, so that a wound structure is formed. To elaborate more on the avoidance portion A, the avoidance portion A in the multilayer group G4 may be provided on an inner side than the coil conductor CM arranged along the outer edge of the magnetic layer ML of the multilayer group G2, thereby avoiding the second through-conductor TH2.

The multilayer group G5 includes a magnetic layer ML, a second through-conductor TH2 that electrically connects the second through-conductor TH2 of the multilayer group G4 and the second outer electrode E2, and a via conductor V that connects adjacent coil conductors CM in the stacking direction. The via conductor V is arranged adjacent to the second through-conductor TH2 at a position where it can be electrically connected to the end portion of the coil conductor CM in the multilayer group G4.

The multilayer group G6 includes a magnetic layer ML, a second through-conductor TH2 that electrically connects the second through-conductor TH2 of the multilayer group G5 and the second outer electrode E2, and a coil conductor CM. The coil conductor CM of the multilayer group G6 constitutes one winding of the coil C. More specifically, the coil conductor CM is arranged along the outer edge of the magnetic layer ML while avoiding the second through-conductor TH2 with an avoidance portion A, and the end portions of the coil conductor CM are separated from each other, so that a wound structure is formed. To elaborate more on the avoidance portion A, the avoidance portion A in the multilayer group G6 may be provided on an inner side than the coil conductor CM arranged along the outer edge of the magnetic layer ML of the multilayer group G2, thereby avoiding the second through-conductor TH2.

The multilayer group G7 includes a magnetic layer ML, a second through-conductor TH2 that electrically connects the second through-conductor TH2 of the multilayer group G6 and the second outer electrode E2, and a first through-conductor TH1 that electrically connects the coil conductor CM of the multilayer group G6 and a first outer electrode E1. The first through-conductor TH1 is arranged in a corner portion of the magnetic layer ML.

As described above, when the element body B has a multilayer structure including the multilayer groups G1 to G7, the design of the multilayer inductor 1 has more flexibility. For example, when manufacturing the multilayer inductor 1 with the first outer electrode E1 and the second outer electrode E2 provided on the bottom surface (the first main surface B1) of the element body B, it is easier to extend the coil C to the side of the bottom surface. The multilayer structure including the above multilayer groups G1 to G7 may be formed by stacking a material constituting the magnetic layer ML, a material constituting the coil conductor CM, and a material constituting the through-conductor and the via conductor by sequentially applying (for example, by screen printing or the like) these materials from the second main surface B2 or the first main surface B1 of the element body B. In such a case, each of the multilayer groups G1 to G7 may be formed by repeatedly applying the aforesaid materials until the magnetic layer ML, the coil conductor CM, and the through-conductor and the via conductor reach the desired thickness.

### Magnetic Body

The magnetic body M (see FIGS. 2 to 4B) formed by stacking the magnetic layers ML contains iron powder MP, which is composed of a magnetic material. The term “iron powder” referred to in the present specification is not limited to being strictly powdery and also includes powdery substances that are sintered by heat treatment (firing) as to be described later. The iron powder MP may contain Fe and/or Si. More specifically, the iron powder MP may be Fe particles or particles of a Fe alloy. Examples of the Fe alloy include a Fe-Si alloy, a Fe-Si-Cr alloy, a Fe-Si-Al alloy, a Fe-Si-B-P-Cu-C alloy, and/or a Fe-Si-B-Nb-Cu alloy. The iron powder MP may also contain impurities such as Cr, Mn, Cu, Ni, P, S, and/or Co that are not intended for manufacture. The iron powder MP may also be contained in the magnetic paste, as to be detailed later in the description of the manufacturing method. Therefore, the iron powder may contain elements (for example, Cr, Al, Li, and Zn) that are more easily oxidized than Fe, which is added during the preparation of the magnetic past.

The surface of the iron powder MP described above may be covered with an insulating film (not shown). When the surface of the iron powder MP is covered with the insulating film, the insulation between the iron powder MP can be increased. A sol-gel method, a mechanochemical method, or the like can be used to form the insulating film on the surface of the iron powder MP. The material forming the insulating film may be an oxide of, for example, P and/or Si. The insulating film may be an oxide film formed by oxidizing the surface of iron powder MP. The thickness of the insulating film is preferably 1 nm or more and 50 nm or less (i.e., from 1 nm to 50 nm), more preferably 1 nm or more and 30 nm or less (i.e., from 1 nm to 30 nm), and still more preferably 1 nm or more and 20 nm or less (i.e., from 1 nm to 20 nm). For example, a section obtained by polishing a sample of the inductor is photographed by a scanning electron microscope (SEM) to obtain a SEM photograph, and the thickness of the insulating film covering the surface of the iron powder MP can be measured from the obtained SEM photograph.

The average particle diameter of the iron powder MP in the magnetic body M is preferably 1 μm or more and 30 μm or less (i.e., from 1 μm to 30 μm), more preferably 1 μm or more and 20 μm or less (i.e., from 1 μm to 20 μm), and still more preferably 1 μm or more and 10 μm or less (i.e., from 1 μm to 10 μm). The average particle diameter of the iron powder MP in the magnetic body M can be measured by the procedure described below. Cutting a sample of the multilayer inductor to obtain a sample section. Specifically, obtaining a section shown in FIG. 3 (i.e., a sample section perpendicular to the mounting surface and end surfaces of the element body through the first through-conductor of the element body). Photographing a plurality of (five, for example) areas (for example, 130 μm×100 μm) on the obtained section by SEM to obtain SEM images, and analyzing the obtained SEM images using image analysis software (for example, image analysis software WinROOF2021 (made by Mitani Corporation)) to obtain circle-equivalent diameters of the iron powder MP. The average value of the circle-equivalent diameters obtained is regarded as the average particle diameter of the metallic magnetic particles.

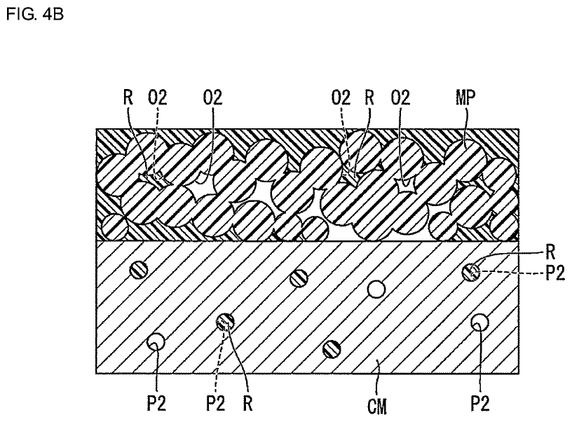

Here, as a new finding of the present disclosure, the inventors of the present application have found that even when the iron powder MP in the magnetic layer ML is sintered by firing, voids O (see FIGS. 4A and 4B) are generated between the iron powder MP, and element body strength is reduced due to the presence of the voids. The term “void” referred to in the present specification is intended to mean a space between adjacent powdery bodies. In other words, the term “void” is intended to mean a space defined by the positional relationship between adjacent powdery bodies. The voids O can be observed by cutting a sample of the multilayer inductor 1 to obtain a sample section and observing the SEM image of the sample section as described above. As a concrete method for specifying the voids O, when an SEM image is acquired with the observation area of the sample section set to 130 μm×100 μm and the voids O area and non-voids area in the magnetic body M are analyzed by the image analysis software, the area ratio of the voids O to the entire observation area may be 10% or more and 40% or less (i.e., from 10% to 40%).

In the multilayer inductor 1 according to the present embodiment, in order to reduce the decrease in element body strength due to the presence of the voids O, the element body B after firing is impregnated with a resin material to provide a resin R in the voids O. By providing the resin R in the voids O inside the magnetic body M, the element body strength can be further improved.

The resin provided in the voids O may contain epoxy resin, silicone resin, or phenolic resin. If the resin that enters the voids O inside the magnetic body M is epoxy resin or phenolic resin, the strength of the element body B can be further increased.

### Coil

The coil includes a plurality of coil conductors CM in the stacking direction (for example, the height direction T). The coil of the present embodiment may have, for example, about 2.75 turns by the multilayer groups G2, G4, and G6, as shown in FIGS. 2 and 3.

The thicknesses of the coil conductors CM in the respective multilayer groups may be the same. An example of the material of the coil conductor CM may be a metallic conductor such as Ag, Cu, and/or Pd. The coil conductor CM may be formed, for example, by applying a conductive paste on the magnetic layer ML described above.

Here, as a new finding of the present disclosure, the inventors of the present application have found that, depending on the material and the firing conditions of the coil conductor, pores P (see FIGS. 4A and 4B) can be generated in the coil conductor CM that constitutes the coil, after firing the element body. The term “pore” referred to in the present specification is intended to mean a cavity of minute size. The pores P can be observed by cutting a sample of the multilayer inductor to obtain a sample section and observing a SEM image of the sample section as described above. The pores P may be, for example, about 1 μm in circle-equivalent diameter as analyzed by the image analysis software. As a more concrete method of specifying the pores P, when the observation area of the sample section is set to 150 μm×70 μm, the average size of the pores P obtained by extracting 10 pores P existing in the observation area from the largest to the smallest may be 1 μm or more and 6 μm or less (i.e., from 1 μm to 6 μm). As another method of specifying the pores P, when an SEM image is acquired with the observation area of the sample section set to 150 μm×70 μm and the pores P area and non-pores area in the coil conductor CM are analyzed by the image analysis software, the area ratio of the pores P to the entire observation area may be 3% or more and 30% or less (i.e., from 3% to 30%).

In the multilayer inductor 1 of the present embodiment, in order to reduce the decrease in element body strength due to the presence of the pores P, the element body B after firing is impregnated with a resin material. Due to the impregnation, the resin R is provided in the voids O, and the resin R is provided also in the pores P. More specifically, the resin R is provided on the upper and lower surfaces of the coil conductor CM, which are at least a part of the pores P in the coil conductor CM in the vicinity of the magnetic layer ML (see FIGS. 4A and 4B). The term “in the vicinity of the magnetic layer” referred to in the present specification is intended to mean a range from the interface between the coil conductor and the magnetic layer up to 15 μm. Therefore, the element body strength can be further improved compared to the multilayer electronic component described in the related art. The resin R in the pores P and the resin R in the voids O may be the same material from the viewpoint that they are provided by impregnating the element body B after the firing with the resin material.

### Through-Conductors and Via Conductors

The coil C may include through-conductors and via conductors. The through-conductors may include a first through-conductor TH1 and a second through-conductor TH2. The first through-conductor TH1 and the second through-conductor TH2 may be provided inside the element body B. The first through-conductor TH1 and the second through-conductor TH2 may be exposed from the mounting surface (the first main surface B1) of the element body B.

The first through-conductor TH1 may connect, among the end portions of the coil C, an end portion of a coil conductor CM closest to the bottom surface (the first main surface B1) of the element body B and the first outer electrode E1. The first through-conductor TH1 may extend along the stacking direction (for example, the height direction T). The first through-conductor TH1 may have a multilayer structure.

The second through-conductor TH2 may connect the other end portion of the coil C and the second outer electrode E2. The second through-conductor TH2 may extend along the stacking direction (for example, the height direction T). The second through-conductor TH2 may have a multilayer structure.

The via conductor V may electrically connect coil conductors CM provided in the multilayer groups adjacent to each other in the stacking direction. In other words, the length of the via conductor V in the stacking direction may be shorter than the length of the first through-conductor TH1 or the length of the second through-conductor TH2. The via conductor V may have a multilayer structure.

An example of the material of the through-conductor and the via conductor may be a metallic conductor such as Ag, Cu, and/or Pd. The material of the through-conductor and the via conductor may be the same as the material of the coil conductor CM or may be different from the material of the coil conductor CM. The through-conductor and the via conductor may be formed, for example, by forming a through-conductor in the magnetic layer ML described above and applying a conductive paste to the through-conductor.

### Outer Electrodes

The outer electrodes may include the first outer electrode E1 and the second outer electrode E2, as shown in FIG. 1. The first outer electrode E1 and the second outer electrode E2 may be provided on the first main surface B1 (the bottom surface) of the element body B and may be electrically connected to the coil C. When the outer electrodes are provided on the first main surface B1 of the element body B, it is possible to properly mount the multilayer inductor 1 on a mounting substrate or the like.

The first outer electrode E1 may function as an input electrode and/or an output electrode with respect to the coil C. The first outer electrode E1 may be provided only on the first main surface B1 of the element body B, or may be provided to straddle the first main surface B1 of the element body B and at least one of the second end surface B4, the first side surface B5, and the second side surface B6.

The second outer electrode E2 may function as an input electrode and/or an output electrode with respect to the coil C. The second outer electrode E2 may be provided only on the first main surface B1 of the element body B, or may be provided to straddle the first main surface B1 of the element body B and at least one of the first end surface B3, the first side surface B5, and the second side surface B6.

As a suitable aspect of the outer electrode, the flat area of the outer electrode when viewed from the side of the mounting surface of the element body B may be larger than the flat area of the through-conductor. By making the flat area of the outer electrode relatively large, when mounting the multilayer inductor 1 on a mounting substrate or the like, the electrode of the mounting substrate and the outer electrode of the multilayer inductor 1 can be easily aligned.

For example, the outer electrode may be made of various materials such as Cu, Ni, and/or Sn. The outer electrode may be formed of one layer or may have a multilayer structure of two or more layers. The outer electrode may be formed by any method; however, the outer electrode may be, for example, a plated electrode formed by direct plating (for example, electrolytic plating) on the through-conductor. When forming the outer electrode by plating, the element body B must be immersed in a plating solution; however, as described above, since the resin R is provided in the voids O of the element body B (the magnetic body M), it is possible to reduce the penetration of the plating solution into the voids and the like inside the magnetic body.

As described above, with the multilayer inductor 1 of the present disclosure, since the resin is provided in the voids O inside the magnetic body M and in a part of the pores P in the coil conductor CM at least in the vicinity of the magnetic layer ML, element body strength can be increased by reducing the voids O and pores P.

### Aspects of Resin Impregnation

With respect to a suitable aspect of the resin impregnation of the voids O, the resin impregnation rate of voids O1 of the element body B may be higher than the resin impregnation rate of voids O2, which are located on further inner side of the element body B than the voids O1. The impregnation rate can be measured by the procedure described below. Cutting a sample of the multilayer inductor to obtain a sample section. Specifically, obtaining a section shown in FIG. 3 (i.e., a sample section perpendicular to the mounting surface and end surfaces of the element body through the first through-conductor of the element body). Photographing the obtained section by SEM-EDX to obtain an image, and analyzing the obtained image using the image analysis software to obtain the impregnation rate. The above aspect is described in detail with reference to FIGS. 3 to 4B.

The specific method of impregnating the element body B with the resin is described in detail in a method of manufacturing the multilayer inductor to be described later; the resin R is impregnated from the outer surface of the element body B, and the resin R is more easily impregnated into the outer side portion of the element body B than into the inner side portion of the element body B. In other words, as schematically shown in FIG. 4A, the voids O1 in a Z1 portion of the element body B are relatively more impregnated with the resin, while as schematically shown FIG. 4B, the voids O2 in a Z2 portion, which are located on an inner side of the element body B than the voids O1 in the Z1 portion, are less impregnated with the resin than the voids O1 in FIG. 4A.

With such an aspect of the resin impregnation, the resin impregnation rate of the voids O1 located on the outer surface side of the element body B is higher than the resin impregnation rate of the voids O2, so that when the outer electrode is a plated electrode, the penetration of the plating solution into the magnetic body M can be further reduced. The same tendency of the resin impregnation for the voids O is also true for the pores P; the resin impregnation rate of pores P1 may be higher than the resin impregnation rate of pores P2, which are located on an inner side of the element body B than the pores P1.

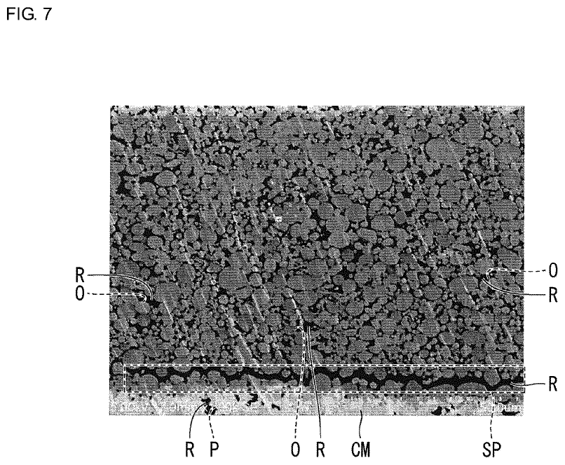

As a further suitable aspect of the resin impregnation, in addition to the voids O inside the magnetic body M and the pores P of the coil conductor CM, the resin R may be provided in a space SP located between the magnetic layer ML and the coil conductor CM in the stacking direction. The above aspect is described in detail with reference to FIG. 7.

The expression “space located between the magnetic layer and the coil conductor in the stacking direction” referred to in the present specification is a different concept from the “void” between adjacent powdery bodies, and is intended to mean a space specified by the positional relationship between the magnetic layer ML and the coil conductor CM. More specifically, the expression “space located between the magnetic layer and the coil conductor in the stacking direction” is intended to mean a space in the vicinity of the interface between the magnetic layer ML and the coil conductor CM and extending along the interface. The term “in the vicinity of the interface” is intended to mean a range from the interface between the magnetic layer ML and the coil conductor CM up to about the particle diameter of the iron powder MP in the stacking direction, and may be surrounded by the magnetic layer ML. More specifically, the term “in the vicinity of the interface” is intended to mean a range from the interface between the magnetic layer and the coil conductor to ±15 μm in the stacking direction.

The spacing of the space SP can be measured by, as described above, cutting a sample of the multilayer inductor to obtain a sample section and observing the maximum length of the space SP in the stacking direction from a SEM image of the sample section. The space SP may be, for example, about 2 μm in size.

Thus, by providing the resin R in the space SP between the magnetic layer ML and the coil conductor CM in the stacking direction, peeling strength between the magnetic layer ML and the coil conductor CM can be further improved.

### Variation of Multilayer Inductor of First Embodiment

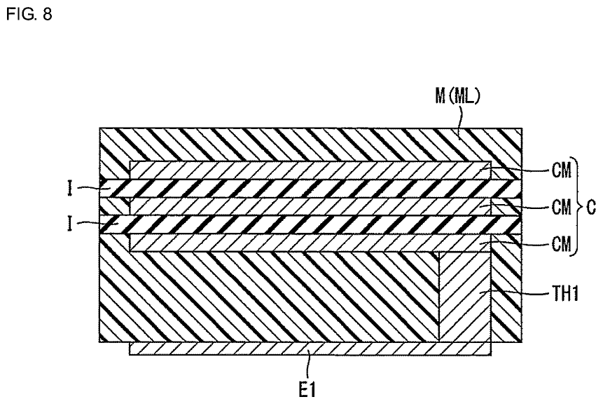

As a variation of the multilayer inductor 1 of the first embodiment, an insulating layer I may be arranged between the magnetic layers ML, as shown in FIG. 8. More specifically, in the multilayer groups G1 to 7 shown in FIG. 2, the insulating layer I may be arranged between the magnetic layers ML in the stacking direction. When arranging the insulating layer I between the coil conductors CM, the through-conductor and the via conductor may be provided in the insulating layer I. When the insulating layer I is arranged between the coil conductor layers, the possibility of the coil conductors CM inside the magnetic body M short-circuiting each other can be further reduced. The insulating layer I may be provided only between some of the magnetic layers ML, instead of between all the magnetic layers ML.

### Multilayer Inductor According to Second Embodiment

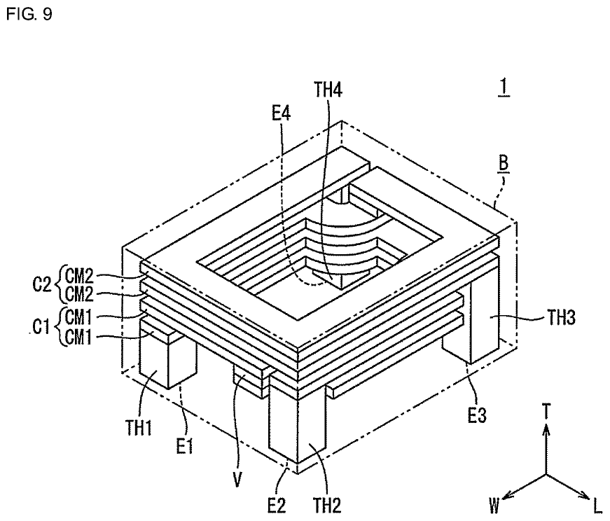

Next, a multilayer inductor 1 of a second embodiment will be described with reference to FIG. 9. The multilayer inductor 1 of the second embodiment differs from the inductor of the first embodiment described above in configuration of the coil. The following description will focus on the points that differ from the multilayer inductor described in the above embodiment.

The coil of the multilayer inductor 1 of the present embodiment may be arranged in two or more overlapping each other in plan view from the stacking direction. In other words, a first coil C1 and a second coil C2 may be provided within an element body B. The first coil C1 and the second coil C2 may be magnetically coupled to each other. For example, the coupling coefficient between the first coil C1 and the second coil C2 is 0.1 or more and 0.8 or less (i.e., from 0.1 to 0.8). Within the element body B, two coils including only the first coil C1 and the second coil C2 may be provided, and alternatively three or more coils including the first coil C1 and the second coil C2 may be provided.

### First Coil

The first coil C1 includes a plurality of first coil conductors CM1 that constitute the first coil C1 in the stacking direction (for example, the height direction T). Adjacent first coil conductors CM1 are connected to each other via a via conductor V. The number of turns of the first coil C1 may be 1.75 formed by including the first coil conductors CM1 formed in two different multilayer groups in the stacking direction. Note that the number of turns is not limited to 1.75 and may be 2 or more, for example, by stacking the first coil conductors CM1 in the stacking direction.

### Second Coil

The second coil C2 is arranged above the first coil C1 in the height direction T and includes a plurality of second coil conductors CM2 that constitute the second coil in the stacking direction (for example, the height direction T). Adjacent second coil conductors CM2 are connected to each other via a via conductor V. The number of turns of the second coil C2 may be 1.75 formed by including the second coil conductors CM2 formed in two different multilayer groups in the stacking direction. Note that the number of turns is not limited to 1.75 shown in the drawing and may be 2 or more, for example, by stacking the first coil conductors CM1 in the stacking direction. The number of layers of the second coil conductor CM2 may be the same as or different from the number of layers of the first coil conductor 51.

### Through-Conductors and Outer Electrodes

The through-conductors include a first through-conductor TH1, a second through-conductor TH2, a third through-conductor TH3, and a fourth through-conductor TH4. The first through-conductor TH1, the second through-conductor TH2, the third through-conductor TH3 and the fourth through-conductor TH4 are arranged inside the element body B. The first through-conductor TH1, the second through-conductor TH2, the third through-conductor TH3 and the fourth through-conductor TH4 are exposed from the mounting surface (the first main surface B1) of the element body B.

The first through-conductor TH1 connects, among the end portions of the first coil C1, an end portion of a first coil conductor CM1 closest to the bottom surface (a first main surface B1) of the element body B and a first outer electrode E1. The first through-conductor TH1 may extend along the stacking direction (for example, the height direction T). The first through-conductor TH1 may have a multilayer structure.

The second through-conductor TH2 connects the other end portion of the first coil C1 and a second outer electrode E2. The second through-conductor TH2 may extend along the stacking direction (for example, the height direction T). The second through-conductor TH2 may have a multilayer structure.

The third through-conductor TH3 connects, among the end portions of the second coil C2, an end portion of a second coil conductor CM2 closest to the bottom surface (the first main surface B1) of the element body B and a third outer electrode E3. The third through-conductor TH3 may extend along the stacking direction (for example, the height direction T). The third through-conductor TH3 may have a multilayer structure.

The fourth through-conductor TH4 connects the other end portion of the second coil C2 and a fourth outer electrode E4. The fourth through-conductor TH4 may extend along the stacking direction (for example, the height direction T). The fourth through-conductor TH4 may have a multilayer structure.

As shown in FIG. 9, the outer electrodes include the first outer electrode E1, the second outer electrode E2, the third outer electrode E3, and the fourth outer electrode E4. The first outer electrode E1 and the second outer electrode E2 are provided on the first main surface B1 of the element body B and are electrically connected to the first coil C1. The third outer electrode E3 and the fourth outer electrode E4 are provided on the first main surface B1 of the element body B and are electrically connected to the second coil C2. In the multilayer inductor 1, the first main surface B1 of the element body B can be regarded as the mounting surface.

Even in the multilayer inductor 1 of the second embodiment, a resin is provided in voids O inside the magnetic body M and in a part of pores P in the coil conductor CM at least in the vicinity of the magnetic layer ML. Therefore, the element body strength can be increased by reducing the voids O and the pores P.

### Multilayer Inductor Array

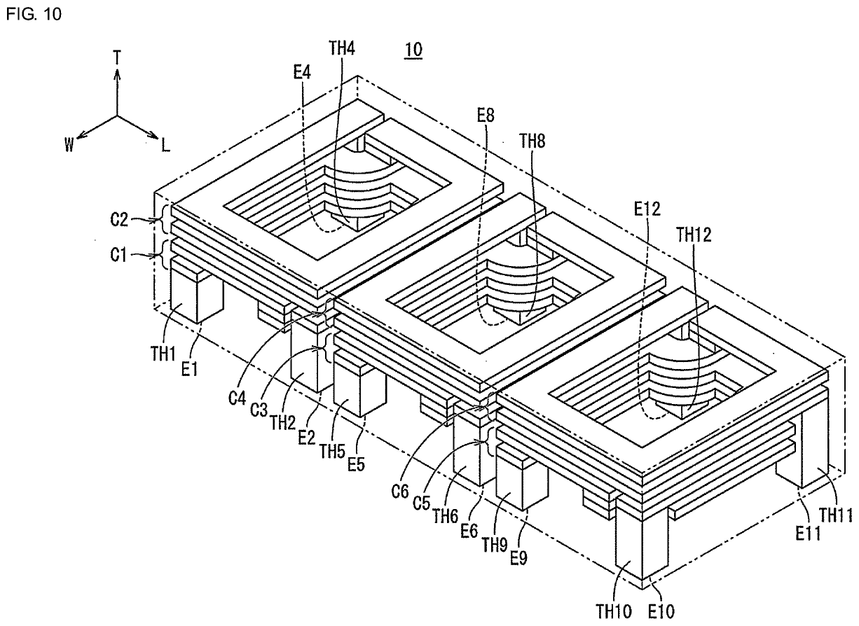

Next, a multilayer inductor array of the present disclosure is described with reference to FIG. 10. In a multilayer inductor array 100 of the present disclosure, coils are arranged in two or more overlapping each other in plan view from the stacking direction and are arranged side by side in a direction intersecting the stacking direction to form a coil array. Specifically, the multilayer inductor array 10 include a third coil C3 and a fourth coil C4, and a fifth coil C5 and a sixth coil C6, in addition to a first coil C1 and a second coil C2. The third coil C3 and the fifth coil C5 have substantially the same structure as the first coil C1, and the fourth coil C4 and the sixth coil C6 have substantially the same structure as the second coil C2.

The third coil C3 may be electrically connected to a fifth outer electrode E5 and a sixth outer electrode E6. Among the end portions of the third coil C3, an end portion of a third coil conductor layer closest to the bottom surface and the fifth outer electrode E5 may be connected by a fifth through-conductor TH5. The other end portion of the third coil conductor layer and the sixth outer electrode E6 may be connected by a sixth through-conductor TH6.

The fourth coil C4 may be electrically connected to a seventh outer electrode (not shown) and an eighth outer electrode (not shown). Among the end portions of the fourth coil C4, an end portion of a fourth coil conductor layer closest to the bottom surface and the seventh outer electrode may be connected by a seventh through-conductor. The other end portion of the fourth coil conductor layer and the eighth outer electrode may be connected by an eighth through-conductor.

The fifth coil C5 may be electrically connected to a ninth outer electrode E9 and a tenth outer electrode E10. Among the end portions of the fifth coil C5, an end portion of a fifth coil conductor layer closest to the bottom surface and the ninth outer electrode E9 may be connected by a ninth through-conductor TH9. The other end portion of the fifth coil conductor layer and the tenth outer electrode E10 may be connected by a tenth through-conductor TH10.

The sixth coil C6 may be electrically connected to an eleventh outer electrode E11 and a twelfth outer electrode E12. Among the end portions of the sixth coil C6, an end portion of a sixth coil conductor layer closest to the bottom surface and the eleventh outer electrode E11 may be connected by an eleventh through-conductor TH11. The other end portion of the sixth coil conductor layer and the twelfth outer electrode (not shown) may be connected by a twelfth through-conductor TH12.

Even in the multilayer inductor array 10 of the present disclosure, a resin is provided in voids O inside the magnetic body M and in a part of pores P in the coil conductor CM at least in the vicinity of the magnetic layer ML. Therefore, the element body strength can be increased by reducing the voids O and the pores P.

### Method of Manufacturing Multilayer Inductor

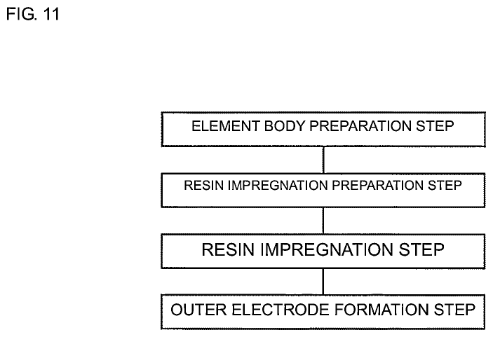

Next, a method of manufacturing the multilayer inductor of the present disclosure is described below following the manufacturing flow shown in FIG. 11. The method of manufacturing the multilayer inductor of the present disclosure may include an element body preparation step, a resin impregnation preparation step, a resin impregnation step, and an outer electrode formation step. The following is a detailed description of the steps.

### Element Body Preparation Step

First, preparing a magnetic paste that constitutes the magnetic layer ML in the multilayer group described in FIG. 2, a conductor paste that constitutes the coil conductor CM in the multilayer group described in FIG. 2, and a non-magnetic paste that constitutes the non-magnetic layer between the coil conductors CM.

As an example of making the magnetic paste, preparing iron powder of a Fe-Si alloy or a Fe-Si-Cr alloy with a 50% cumulative particle diameter (D50), on volume basis, of 2 μm or more and 20 μm or less (i.e., from 2 μm to 20 μm). Adding cellulose, polyvinyl butyral (PVB), or the like, as a binder, and a mixture of terpineol and butyl diglycol acetate (BCA), as a solvent, to the iron powder, and kneading the result to make the magnetic paste.

When a Fe-Si alloy is used as the iron powder, the Si content is preferably 2.0 at % or more and 8.0 at % or less (i.e., from 2.0 at % to 8.0 at %). When a Fe-Si-Cr alloy is used as the iron powder, the Si content is preferably 2.0 at % or more and 8.0 at % or less (i.e., from 2.0 at % to 8.0 at %). When a Fe-Si-Cr alloy is used as iron powder, the Cr content is preferably 0.2 at % or more and 6.0 at % or less (i.e., from 0.2 at % to 6.0 at %).

An insulating film may be applied to the surface of the iron powder. Preferably, the insulating film is a film containing a metal oxide, and more preferably, the insulating film is an oxide of Si. Preferably, the insulating film is formed by sol-gel method. To form an insulating film by sol-gel method, for example, a sol-gel coating agent containing Si alkoxide and an organic chain-containing silane coupling agent are mixed to form a mixed solution. After the mixed solution is adhered to the surface of the metallic magnetic powder, the mixed solution is dehydrated and bonded by applying a heat treatment. Thereafter, the insulating film can be formed by drying at a predetermined temperature.

To make a non-magnetic paste, for example, Fe2O3, ZnO, CuO, and additive ingredients are weighed so that they become a predetermined composition. The weighed material is placed in a ball mill together with pure water, dispersant, and PSZ media, and mixed and ground to obtain a slurry. After drying the obtained slurry, the dried slurry is temporarily baked at a temperature of 700° C. or higher and 800° C. or lower (i.e., from 700° C. to 800° C.) for 2 hours or longer and 3 hours or shorter (i.e., from 2 hours to 3 hours) to obtain a non-magnetic material (temporarily baked powder). A predetermined amount of solvent (for example, ketone solvent), resin (such as polyvinyl acetal), and plasticizer (such as alkyd plasticizer) is added to the non-magnetic material (temporarily baked powder), kneaded with a planetary mixer, and then dispersed with a 3-roll mill to make the non-magnetic paste.

Preferably, the non-magnetic paste contains 40 mol % or more and 49.5 mol % or less (i.e., from 40 mol % to 49.5 mol %) of Fe in terms of Fe2O3, 4 mol % or more and 12mol % or less (i.e., from 4 mol % to 12 mol %) of Cu in terms of CuO, and ZnO, which is the main component, as the remainder. Preferably, in the non-magnetic paste, Mn, Bi, Co, Si, Sn, and/or the like are added to the main component described above as additives according to necessity. The non-magnetic pastes may contain unavoidable impurities.

As a conductor paste, for example, prepare a paste containing Ag as a conductive material

The above-described magnetic paste, non-magnetic paste and conductor paste are used to prepare the multilayer groups G1 to G7 shown in FIG. 2 by screen printing or the like. The unfired element body is pressurized by performing a pressure treatment such as warm isostatic pressing (WIP) or the like to become a multilayer body. After performing the pressure treatment, the multilayer body is placed in a firing furnace, degreased, and then fired in air. The firing temperature is, for example, 600° C. or higher and 800° C. or lower (i.e., from 600° C. to 800° C.). The firing time is, for example, 30 minutes or longer and 90 minutes or shorter (i.e., from 30 minutes to 90 minutes). The element body is prepared by performing the firing.

### Resin Impregnation Preparation Step (an Optional Additional Step)

The resin impregnation preparation step is performed before the resin impregnation step to be described later. Specifically, the resin impregnation preparation step is a step to reduce gas or moisture in the element body or to reduce the viscosity of the resin.

An example of the resin impregnation preparation step includes performing deaeration on the element body after firing to reduce the amount of gas in the element body to thereby make it easier for the resin to be impregnated. The deaeration and the resin impregnation may be repeatedly performed. As another method of the resin impregnation preparation step, heating may be applied to the element body after firing to reduce the moisture in the element body to thereby make it easier for the resin to be impregnated. As further another method of the resin impregnation preparation step, the viscosity of the resin may be lowered by heating the resin to make it easier to impregnate the resin into the element body. By performing such a step, the resin can be effectively impregnated into the element body.

### Resin Impregnation Step

A resin is impregnated into the element body after firing. The resin may contain epoxy resin, silicone resin, and/or phenolic resin. By impregnating the element body with the resin, the resin is provided in the voids inside the magnetic body and in at least a part of the pores in the coil conductor at least in the vicinity of the magnetic layer. Thus, the voids and pores can be reduced, and the element body strength can be increased. Further, it is possible to reduce the penetration of the plating solution or moisture into the element body.

### Outer Electrode Formation Step

The outer electrode formation step is a step of forming outer electrodes that are electrically connected to the coil conductor. The outer electrodes are formed by electrolytic plating at positions where the through-conductors are exposed on the mounting surface (the first main surface B1) of the element body B. The plating material may be Cu. Other examples the plating material include, but are not limited to, Ni-Sn, Ni-Au, Ni-Cu, and/or Cu-Ni-Au. It is possible to cut the element into individual pieces after forming the outer electrodes to manufacture the multilayer inductor of the present embodiment.

As described above, according to the method of manufacturing a multilayer inductor described in the present embodiment, since the resin is provided in the voids inside the magnetic body and in at least a part of the pores in the coil conductor at least in the vicinity of the magnetic layer, it becomes difficult for the magnetic layer and the coil conductor to peel off from each other, and thereby the element body strength can be increased.

### EXAMPLES

The section of the multilayer inductor of the present disclosure is observed by SEM. The structure of the multilayer inductor to be observed is shown in FIGS. 2 to 4B. In other words, as described above, by impregnating the element body after firing with the resin, the resin R is provided in the voids O in the magnetic body M and the resin is provided in at least a part of the pores in the coil conductor CM at least in the vicinity of the magnetic layer ML.

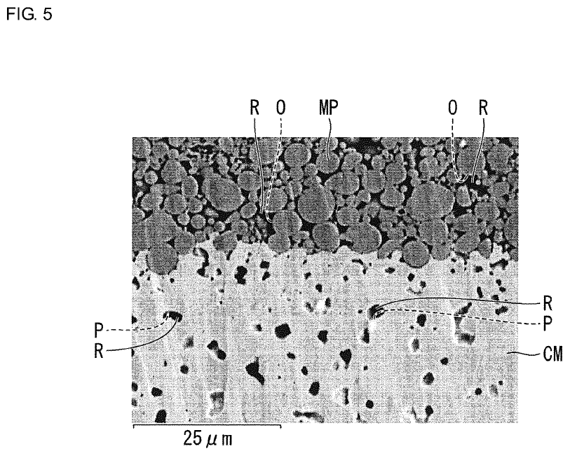

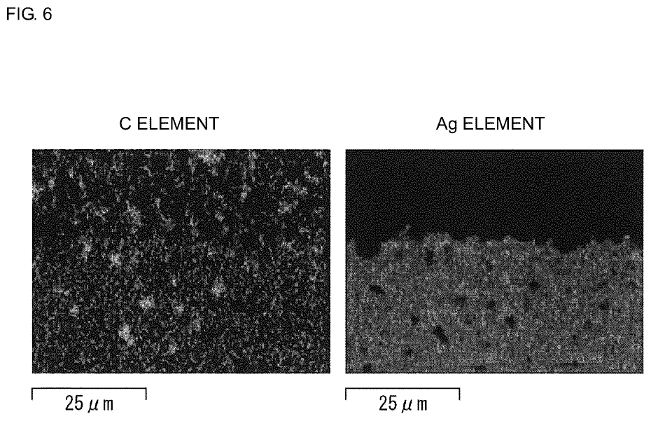

The result of the observation of the section is shown in FIG. 5, and the result of the elemental analysis performed based on FIG. 5 is shown in FIG. 6. According to FIG. 6, a result is obtained in which the C element contained in the resin R enters the voids O inside the magnetic body M and the Ag element contained in the coil conductor CM enters the pores P. The multilayer inductor has higher element body strength than a multilayer inductor without impregnating the resin.

The technical scope of the present disclosure is not to be interpreted solely by the above-described embodiments and is to be defined based on the claims. The technical scope of the present disclosure also includes all modifications inside the meaning and scope of the claims and equivalents.

The multilayer inductor, the multilayer inductor array and the method of manufacturing the multilayer inductor of the present disclosure include the following aspects.
<1> A multilayer inductor comprising an element body that constitutes a magnetic body by stacking magnetic layers containing iron powder and that has a coil obtained by winding a coil conductor inside the magnetic body; and an outer electrode that is electrically connected to the coil conductor. A resin is provided in voids inside the magnetic body, and pores exist in the coil conductor at least in a vicinity of a magnetic layer, and the resin is provided in at least a part of the pores.
<2> The multilayer inductor according to <1>, wherein a space exists between the magnetic layer and the coil conductor in a stacking direction, and the resin is provided in the space.
<3> The multilayer inductor according to <1> or <2>, wherein the outer electrode is arranged on a surface of the element body in the stacking direction via a through-conductor formed in the element body.
<4> The multilayer inductor according to <3>, wherein the outer electrode is a plated electrode formed directly on the through-conductor.
<5> The multilayer inductor according to any one of <1> to <4>, wherein the coil includes two or more coils arranged to overlap each other in plan view from the stacking direction.
<6> The multilayer inductor according to any one of <1> to <5>, wherein, in the voids, a resin impregnation rate of voids located on an outer surface side of the element body is higher than a resin impregnation rate of voids located on an inner side of the element body.
<7> The multilayer inductor according to any one of <1> to <6>, wherein an insulating layer is arranged between the magnetic layers.
<8> The multilayer inductor according to any one of <1> to <7>, wherein the resin contains epoxy resin or phenolic resin.
<9> A multilayer inductor array comprising an element body that constitutes a magnetic body by stacking magnetic layers containing iron powder and that has a coil obtained by winding a coil conductor inside the magnetic body; and an outer electrode that is electrically connected to the coil conductor. The coil includes two or more coils arranged to overlap each other in plan view from the stacking direction and arranged side by side in a direction intersecting the stacking direction to form a coil array. A resin is provided in voids inside the magnetic body, and the resin is provided in at least a part of pores in the coil conductor at least in a vicinity of a magnetic layer.
<10> A method of manufacturing a multilayer inductor comprising an element body preparation step of preparing an element body that constitutes a magnetic body by stacking magnetic layers containing iron powder and that has a coil obtained by winding a coil conductor inside the magnetic body; a resin impregnation step of impregnating a resin into voids inside the magnetic body and into at least a part of pores in the coil conductor at least in a vicinity of a magnetic layer; and an outer electrode formation step of forming an outer electrode electrically connected to the coil conductor.
<11> The method of manufacturing a multilayer inductor according to <10>, wherein the resin impregnation step comprises a resin impregnation preparation step of reducing gas or moisture in the element body or reducing viscosity of the resin before impregnating the resin.

The present disclosure can be used for a multilayer inductor with improved element body strength.

What is claimed is:

1. A multilayer inductor comprising:
an element body including a magnetic body in which magnetic layers including iron powder are stacked, a coil configuration in which a coil conductor is wound inside the magnetic body, and a resin in first voids inside the magnetic body; and
an outer electrode which is electrically connected to the coil conductor,
wherein the coil conductor includes pores at least in a vicinity of a magnetic layer, and the resin is in at least a part of the pores.

2. The multilayer inductor according to claim 1, wherein
a space exists between the magnetic layer and the coil conductor in a stacking direction, and
the resin is in the space.

3. The multilayer inductor according to claim 1, wherein
the outer electrode is on a surface of the element body in a stacking direction via a through-conductor in the element body.

4. The multilayer inductor according to claim 3, wherein
the outer electrode is a plated electrode directly on the through-conductor.

5. The multilayer inductor according to claim 1, wherein
the coil configuration includes two or more coils which overlap each other in plan view from a stacking direction.

6. The multilayer inductor according to claim 1, wherein
a resin impregnation rate of the first voids of the element body is higher than a resin impregnation rate of second voids which are further on an inner side of the element body than the first voids.

7. The multilayer inductor according to claim 1, further comprising:
an insulating layer between the magnetic layers.

8. The multilayer inductor according to claim 1, wherein
the resin includes epoxy resin or phenolic resin.

9. A multilayer inductor array comprising:
an element body including a magnetic body in which magnetic layers including iron powder are stacked, a coil configuration in which a coil conductor is wound inside the magnetic body, and a resin in voids inside the magnetic body; and
an outer electrode which is electrically connected to the coil conductor,
wherein
the coil configuration includes two or more coils which overlap each other in plan view from a stacking direction and are side by side in a direction orthogonal to the stacking direction to configure a coil array,
the resin is in at least a part of pores in the coil conductor at least in a vicinity of a magnetic layer.

10. A method of manufacturing a multilayer inductor comprising:
preparing an element body including a magnetic body in which magnetic layers including iron powder are stacked, and a coil in which a coil conductor is wound inside the magnetic body;
impregnating a resin into voids inside the magnetic body and into at least a part of pores in the coil conductor at least in a vicinity of a magnetic layer; and
forming an outer electrode electrically connected to the coil conductor.

11. The method of manufacturing a multilayer inductor according to claim 10, wherein
the impregnating of the resin comprises preparing for resin by reducing gas or moisture in the element body or reducing viscosity of the resin before impregnating the resin.
